(19) United States
(12) Patent Application Publication
(10) Pub. No.: US 2015/0141155 A1
(43) Pub. Date: May 21, 2015

(54) GAME WITH INCENTIVIZED BEHAVIOR FOR MEDIA ENGAGEMENT

(71) Applicant: THOMSON LICENSING, Issy de Moulineaux (FR)

(72) Inventor: Jagjeet S. KHALSA, San Diego, CA (US)

(21) Appl. No.: 14/083,665

(22) Filed: Nov. 19, 2013

(51) Int. Cl. A63F 13/00

(52) U.S. Cl. CPC A63F 13/00
USPC 463/43

(57) ABSTRACT

A game with incentivized behavior for media engagement and corresponding methods are provided. A method includes storing, in a memory device, a set of behavior-based incentives for a game in which two or more parties compete against each other. The method further includes providing an indication, to at least one party of the two or more parties, that the at least one party has earned one or more of the behavior-based incentives responsive to the at least one party exhibiting or performing one or more predetermined behaviors.

### TECHNICAL FIELD

The present principles relate generally to games and, more particularly, to games with incentivized behavior for media engagement.

### BACKGROUND

Typical media services rely on a recommendation system to engage the user into finding something to watch. This includes a mixture of promoted content, popular content, and content based off of users' previous watching habits. The recommendation system ignores the competitive nature of games as a way to engage users into watching or listening to more media content.

In territorial based games like “Risk” or “Axis and Allies” players attempt to conquer territory with the purpose of winning. This singular purpose provides a limited incentive to the user and contributes to game abandonment. In addition, games such as these treat all users the same not taking into account their preferences. This lack of customization for the user limits engagement and again contributes to abandonment of the game by the user.

Web services such as “Foursquare” broadly incentivize their users including incorporating their current and past behavior, but fail to provide for engaging game play. While user customized incentives may engage users for a time, the limited game play results in some users leaving the service or becoming less engaged.

### SUMMARY

These and other drawbacks and disadvantages of the prior art are addressed by the present principles, which are directed to a game with incentivized behavior for media engagement.

According to an aspect of the present principles, there is provided a method. The method includes storing, in a memory device, a set of behavior-based incentives for a game in which two or more parties compete against each other. The method further includes providing an indication, to at least one party of the two or more parties, that the at least one party has earned one or more of the behavior-based incentives responsive to the at least one party exhibiting or performing one or more predetermined behaviors.

According to another aspect of the present principles, there is provided a method. The method includes monitoring game play behavior in a game in which two or more parties compete against each other using an image capture device. The method further includes providing an indication, to at least one party of the two or more parties, that the at least one party has earned one or more behavior-based incentives responsive to the at least one party exhibiting or performing one or more predetermined behaviors during the game.

According to still another aspect of the present principles, there is provided a game. The game includes a game portion for use by parties to the game during a playing of the game. The game further includes a memory device for storing a set of behaviors and a set of behavior-based incentives. The set of behaviors include game play behaviors and non-game-play behaviors. The game also includes a game play monitor for monitoring the game play behaviors and a non-game-play monitor for monitoring the non-game-play behaviors. The game additionally includes a behavior-based incentive indicator for indicating that one of the parties earned a particular one of the behavior-based incentives responsive to the one of the parties exhibiting or performing a particular one of the behaviors corresponding to the particular one of the behavior-based incentives.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary processing system 100 to which the present principles may be applied, in accordance with an embodiment of the present principles;

FIG. 2 shows a game grid 200 for a game in which two parties compete against each other, in accordance with an embodiment of the present principles;

FIG. 3 shows an example location 310 of an incentive space 300 that one of the parties gets before the game starts, in accordance with an embodiment of the present principles;

FIG. 4 shows another example location 410 of an incentive space 400 that one of the parties gets before the game starts, in accordance with an embodiment of the present principles;

FIG. 5 shows a contested space 500 between two competing parties, in accordance with an embodiment of the present principles;

FIG. 6 shows a result 600 between the parties contending for the contested space 500 with the dot party winning the contested space 500, in accordance with an embodiment of the present principles;

FIG. 7 shows a result 700 between the parties contending for the contested space 500 with the diamond party winning the contested space 500, in accordance with an embodiment of the present principles;

FIG. 8 shows one possible completion result 800 of the game where the diamond party ends up having a contiguous position between the “start” and “finish” large rectangles corresponding to the diamond party;

FIG. 9 shows another possible completion result 900 of the game where the diamond party ends up having all blocks between the “start” and “finish” large rectangles corresponding to the diamond party, in accordance with an embodiment of the present principles;

FIG. 10 shows a method 1000 for playing a game, in accordance with an embodiment of the present principles, in accordance with an embodiment of the present principles; and

FIG. 11 shows a game 1100, in accordance with an aspect of the present principles.

### DETAILED DESCRIPTION

The present principles are directed to a game with incentivized behavior for media engagement. In an embodiment, the present principles are directed to a game that provides an incentive to users who engage in a particular behavior that is encouraged. In an embodiment, the present principles provide a game in which users compete across a grid and/or other gaming structure to win items including, but not limited to, movie credits and so forth. These and other items are readily contemplated by one of ordinary skill in the art given the teachings of the present principles provided herein, while maintaining the spirit of the present principles.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “NB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

As noted above, the present principles are directed to a game with incentivized behavior for media engagement. Thus, in contrast to the prior art, the present principles advantageously provide a game that incentivizes the users of the game to engage in a particular behavior that provides an advantage to the users. For example, the users may gain an advantage in the game (e.g., a better starting position or better next position, receive one or more extra points, one or more titles, and so forth) and/or can win items (e.g., rewards, free movies, etc.) These and other advantages are readily contemplated by one of ordinary skill in the art given the teachings of the present principles provided herein, while maintaining the spirit of the present principles.

In an embodiment, a set of incentives can be determined with respect to a particular game. The incentives are provided responsive to a particular behavior exhibited and/or otherwise performed by the parties to the game. The incentives can be advantages and/or other items. The advantages and/or other items can relate to the game itself (e.g., an advantageous position, etc.), or can be unrelated to the game.

Examples of advantages and/or other items that relate to the game itself include, but are not limited to, receiving an advantageous position in the game (can be a starting position or already-in-play position), receiving one or more extra points, receiving one or more titles, receiving one or more credits for accomplishing something in the game (e.g., levels, etc.), a movie (e.g., depicting a character in the game, an item from the game, etc.), an article of clothing (e.g., depicted on a character in the game), a movie prop replica, and so forth. Examples of advantages and/or other items unrelated to the game include, but are not limited to, movies, clothing, etc. While there is some overlap on some of the items such as movies and clothing, one of ordinary skill in the art can readily appreciate the difference between these items being related versus unrelated to a particular game. Moreover, the present principles are not limited solely to the preceding advantages and items. Thus, these and other advantages and/or items can be provided in accordance with the teachings of the present principles, while maintaining the spirit of the present principles.

For the sake of illustration, one or more examples provided herein after are directed to games with two users. However, it is to be appreciated that the present principles are not limited to games with only two users, and any number of users up to a maximum number limited only by the game itself can play games designed in accordance with the teachings of the present principles, while maintaining the spirit of the present principles.

Moreover, for the sake of illustration, a game is provided and described in which two users compete to make a contiguous line between two zones. However, the present principles are not limited solely to that game, as the present principles can be used to design other incentivized games in accordance with the teachings of the present principles, while maintaining the spirit of the present principles. Also, the present principles can be used to modify existing games to have incentives as described herein.

Further, for the sake of illustration, the FIGURES herein show two parties playing the game described herein, where the respective parties are denoted by “diamond” shading and by “dot” shading. The party denoted by the diamond shading is hereinafter referred to as the diamond party, and the party denoted by the dot shading is hereinafter referred to as the dot party.

Referring back to the aforementioned game in which two users compete to make a contiguous line between two zones, in an embodiment, such a game be implemented and incentivized with respect to a video on demand service environment. In an embodiment, an advantage is given to the users who rent more videos as compared to other users. That is, when two parties engage in the described game, a check is performed to see which one of the parties has rented more videos, whereby the party with the most videos gains an advantage in the game such as going first, having a “free space” in the disclosed game grid, and/or so forth. These and other corresponding advantages are readily determined by one of ordinary skill in the art given the teachings of the present principles provided herein, while maintaining the spirit of the present principles.

It is to be appreciated that the present principles can be implemented with respect to an electronic game or can be implemented with respect to a board game or other type of non-electronic game. However, it is contemplated that some form of processing system with corresponding memory will be used to provide the incentive aspect of the game in accordance with the teachings of the present principles provided herein. That is, it is contemplated that some form of processing system with corresponding memory will be used to, for example, keep score, keep track of exhibited behaviors, keep track of earned incentives, provide a voucher for the earned incentives, and so forth. These and other implementations of a game with incentivized behavior are readily contemplated by one of ordinary skill in the art given the teachings of the present principles provided herein, while maintaining the spirit of the present principles.

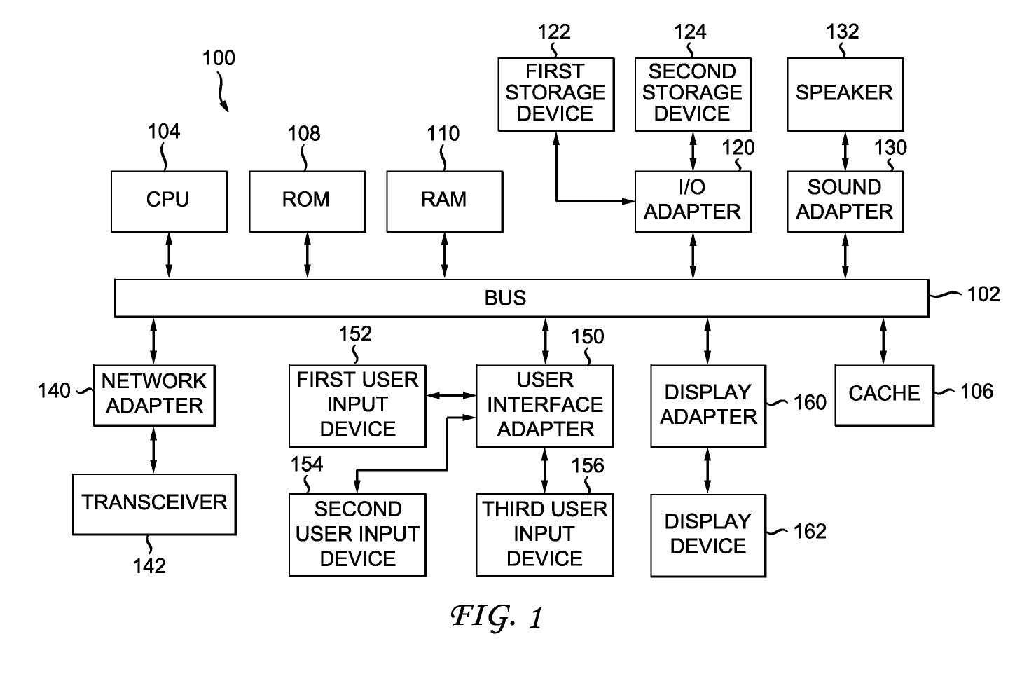

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operative coupled to system bus 102 by the sound adapter 130.

A transceiver 142 is operatively coupled to system bus 102 by network adapter 140.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device (a camera and/or camcorder), a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

A display device 162 is operatively coupled to system bus 102 by display adapter 160.

It is to be appreciated that processing system 100 can be used to implement the incentive aspect of the present principles and can also be used to implement the game itself. The user input devices 152, 154, 156 can be used, for example, to play the game and/or obtain information directed to the incentive aspect of the present principles. For example, the user input device 152, 154, 156 can be used to get the system 100 to provide an indication of what incentives have been earned up to this point, which party earned which incentives, and so forth. Such indication can be provided, for example, via the display device 162 and/or speaker 132. These and other uses for the elements of processing system 100 are readily determined by one of ordinary skill in the art given the teachings of the present principles provided herein, while maintaining the spirit of the present principles.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

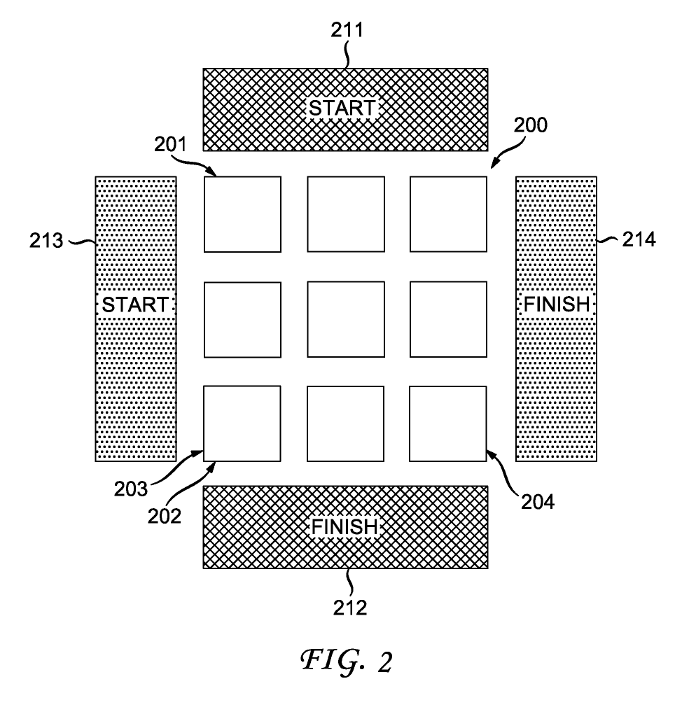

FIG. 2 shows a game grid 200 for a game in which two parties compete against each other, in accordance with an embodiment of the present principles. The objective of the game is to connect one large rectangle to a second large rectangle where both rectangles are associated with the same party. In the embodiment of FIG. 2, the gaming grid 200 includes two pairs of opposing sides. The first pair of opposing sides includes sides 201 and 202, and the second pair of opposing sides includes sides 203 and 204. Thus, regarding the first pair of opposing sides 201 and 202, the first side 201 is in front of rectangle 211 and the second side 202 is in front of rectangle 212. Regarding the second pair of opposing sides 203 and 204, the first side 203 is in front of rectangle 213 and the second side 204 is in front of rectangle 214. Thus, side 201 opposes side 202, and side 203 opposed side 204 on the grid 200.

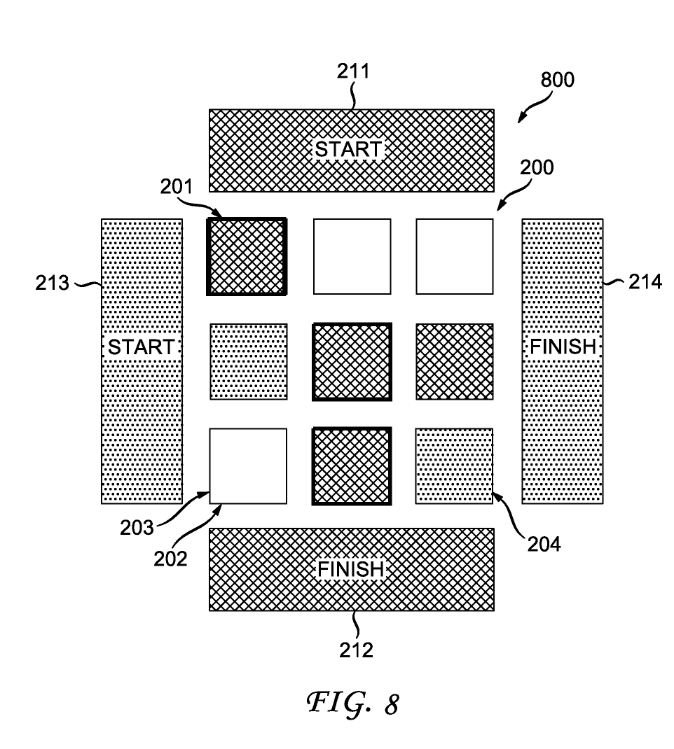

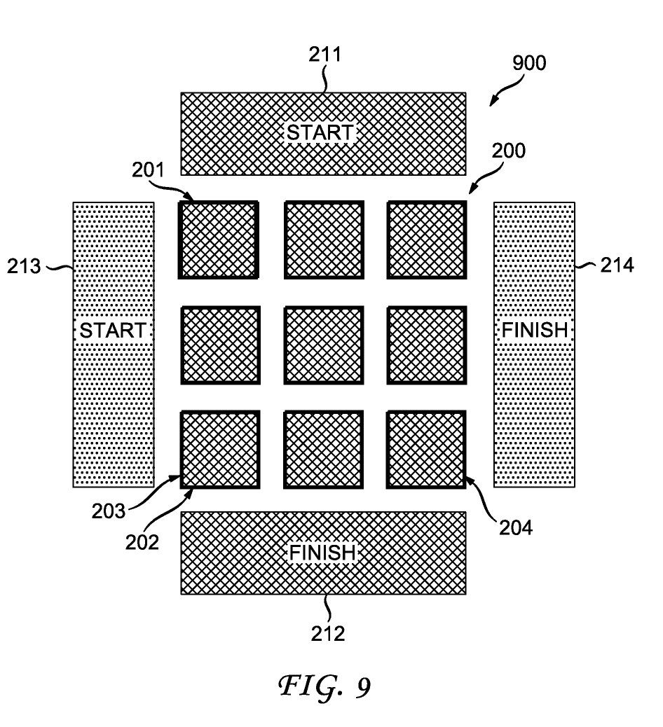

In an embodiment, one party can begin the game starting from one or both sides of one pair of opposing sides, while the other party can begin the game starting from one or both sides of the other pair of opposing sides. In practice, the board would be larger to provide for more game complexity for the players and/or additional players, but not so large as to limit the players from interacting with each other. Thus, in the embodiment of FIG. 2, the diamond party begins on one or both of sides 201 and 202, while the dot party begins on one or both of sides 203 and 204. The rectangles 211 and 212 correspond to the diamond party and one side would represent “start” and the other side would represent “finish” for the diamond party. The rectangles 213 and 214 correspond to the dot party and similarly would represent the “start” and “finish” for the dot party. Each rectangle or “territory” could be acquired in variety of ways. For example, a user might have to answer trivia based off of the user's behavior (e.g., movies the user has watched). For disputed territory, the trivia could be based off of common knowledge between the two users (e.g., movies they both have watched). Territory could also be obtained by watching or rating particular featured content or content with a particular theme. It could also represent content in general. For a party to win the game, different win conditions could be offered. For example, the party could obtain a path between his start and finish blocks within the grid 200. Another win condition would be to take over all the blocks within the grid 200. FIGS. 8 and 9 below respectively show two exemplary winning results. It is to be appreciated that the rules of the game depicted in FIG. 2 are not provided in exhaustive detail, and the present principles are not dependent upon any particular game or rules thereof, but can be applied to any game as readily appreciated by one of ordinary skill in the art, while maintaining the spirit of the present principles.

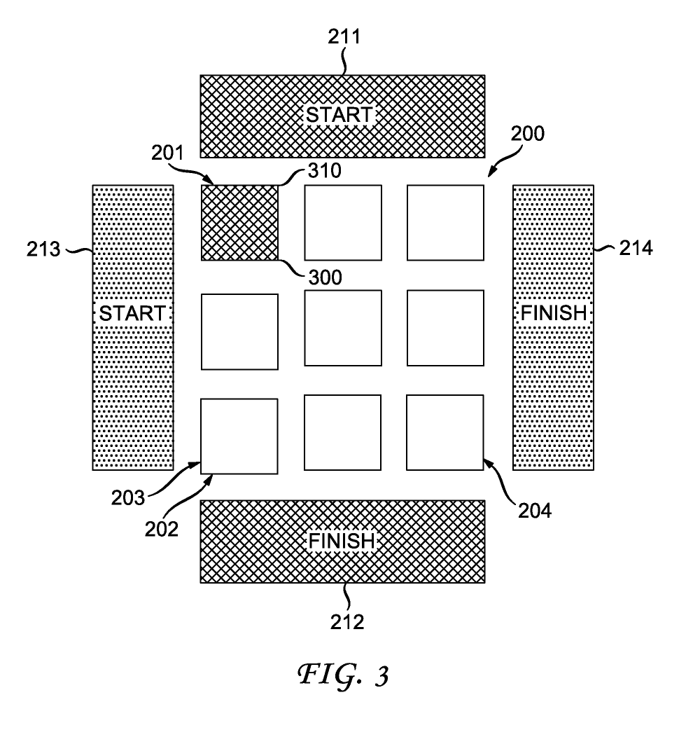

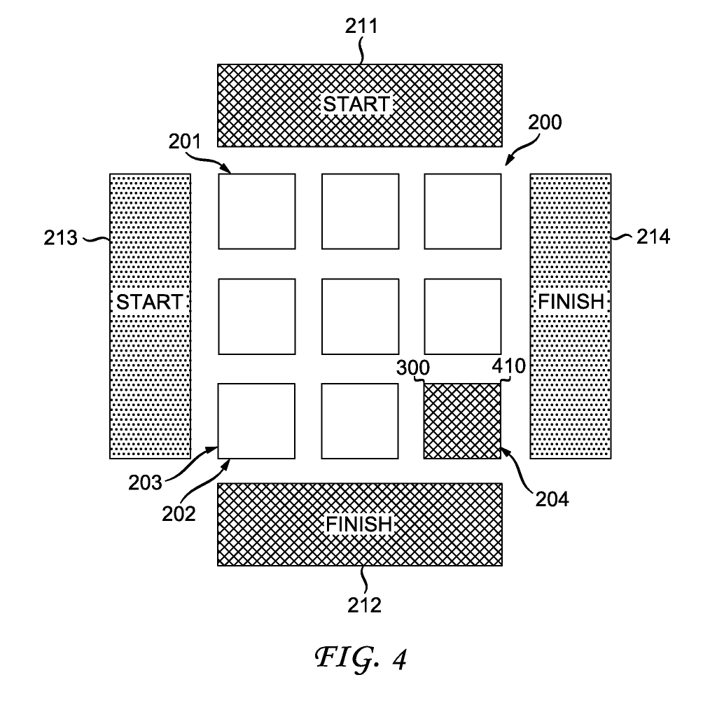

FIG. 3 shows an example location 310 of an incentive space 300 that one of the parties gets before the game starts, in accordance with an embodiment of the present principles. FIG. 4 shows another example location 410 of the incentive space 300 that one of the parties gets before the game starts, in accordance with an embodiment of the present principles. In an embodiment, the party receiving the incentive space (herein after the “receiving party”) is essentially permitted to designate the free space between different areas. This incentive space is given because the receiving party has engaged in a particular behavior, In this example, the behavior can be a purchasing behavior such as, for example, renting more movies than the party they are competing against.

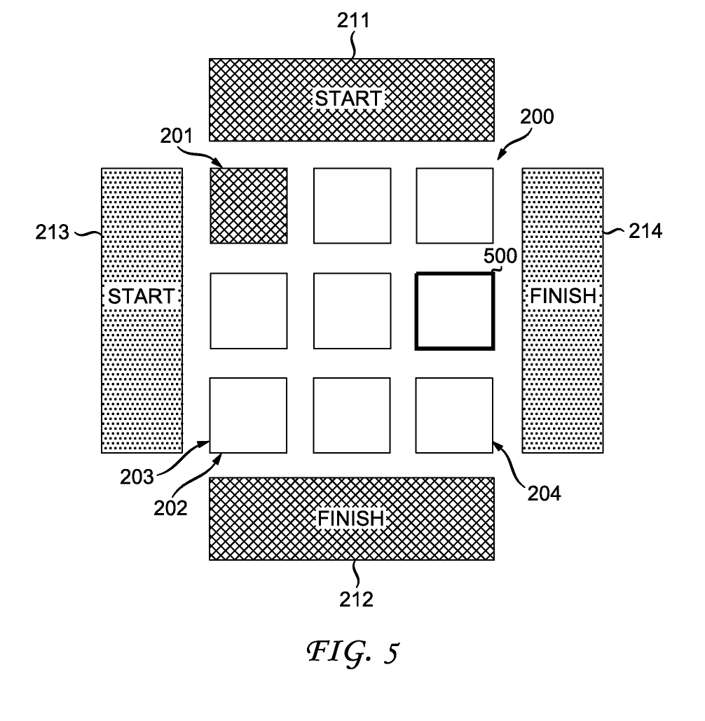

FIG. 5 shows a contested space 500 between two competing parties, in accordance with an embodiment of the present principles. The contested space 500 is also outlined in a bold outline for the sake of illustration. The contested space 500 can be won (obtained) by answering questions about different movies/television shows, performing an action with an input device, and/or so forth. These and other activities for which an advantage is provided are readily determined by one of ordinary skill in the art given the teachings of the present principles provided herein, while maintaining the spirit of the present principles.

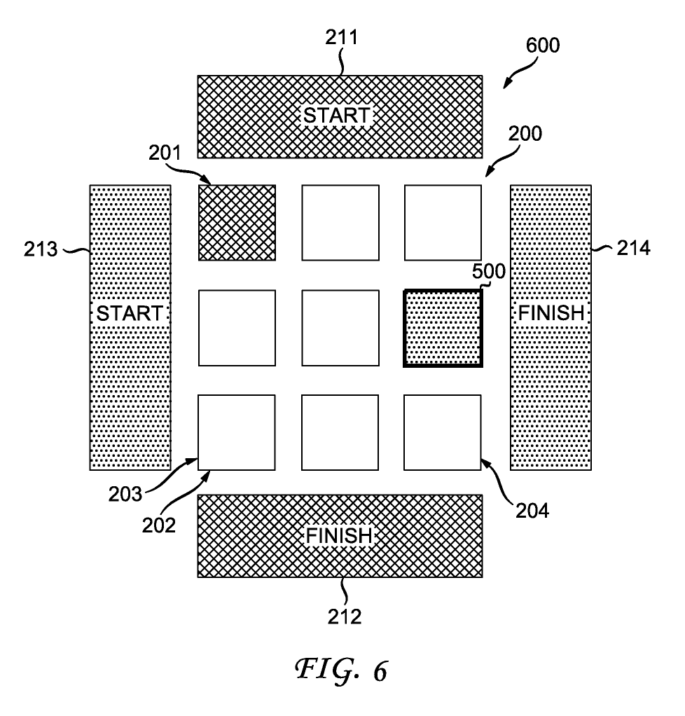

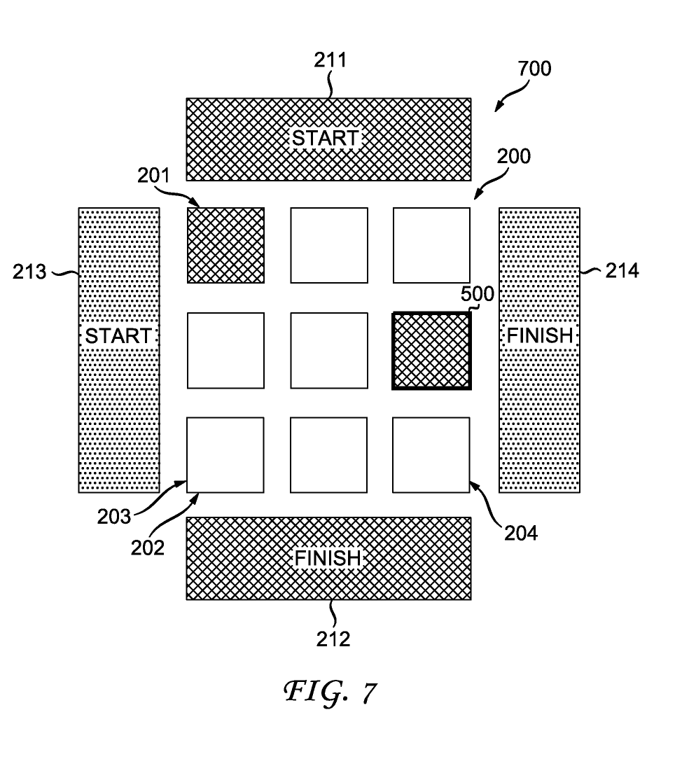

FIG. 6 shows a result 600 between the parties contending for the contested space 500 with the dot party winning the contested space 500, in accordance with an embodiment of the present principles. FIG. 7 shows a result 700 between the parties contending for the contested space 500 with the diamond party winning the contested space 500, in accordance with an embodiment of the present principles.

FIG. 8 shows one possible completion result 800 of the game where the diamond party ends up having a contiguous position between “start” and “finish” large rectangles corresponding to the diamond party, in accordance with an embodiment of the present principles. FIG. 9 shows another possible completion result 900 of the game where the diamond party ends up having all blocks between the “start” and “finish” large rectangles corresponding to the diamond party, in accordance with an embodiment of the present principles.

A winning party can receive extra movie rentals, points, titles, and other incentives which would encourage the party to play more games in the future and/or engage in additional purchasing behavior.

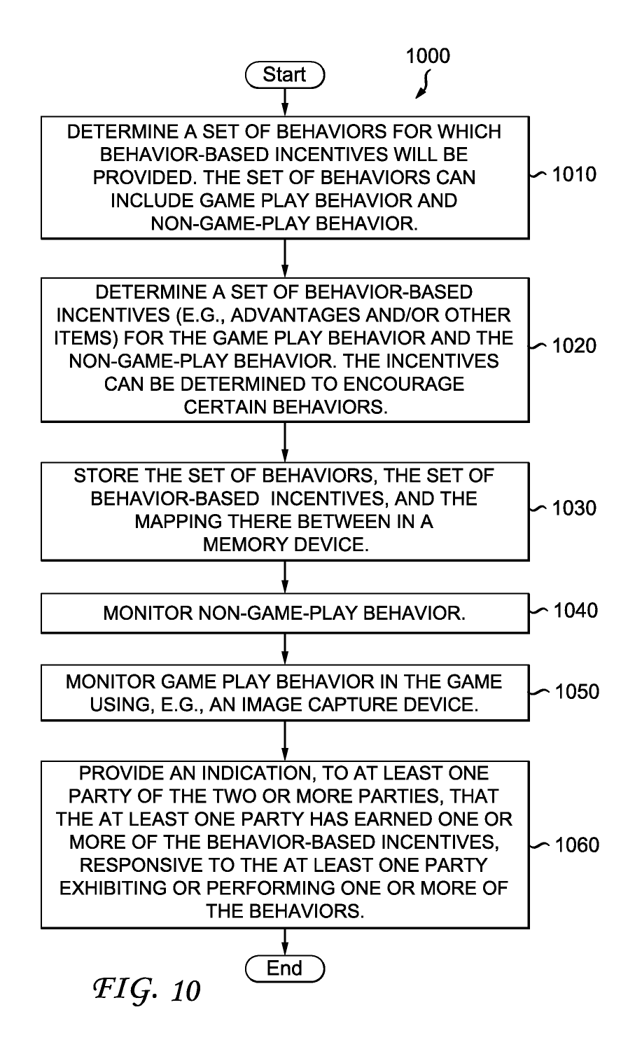

FIG. 10 shows a method 1000 for playing a game, in accordance with an embodiment of the present principles.

At step 1010, determine a set of behaviors for which behavior-based incentives will be provided. The set of behaviors can include game play behavior and non-game-play behavior. The game play behavior corresponds to a game in which two or more parties compete against each other. “Game play behavior” refers to behavior performed during the course of a game and involves behavior directly related to the game. “Non-game-play behavior refers to behavior that is not necessarily performed during the course of the game and can involve behavior related or unrelated to the game itself. For example, non-game-play behavior can include purchasing behavior. The behaviors in the set can be considered patterns that are matched to user (game player) behavior. Moreover, in an embodiment, it is to be appreciated that the behavior-based incentives can be enabled responsive to one of more of the corresponding behaviors being performed by a party to the game. Thus, at any given time, one party may have the behavior-based incentives enabled while the other parties do not (until they also perform a corresponding incentive enabling behavior).

At step 1020, determine a set of behavior-based incentives for the game play behavior and/or the non-game-play behavior. The behavior-based incentives are to be provided responsive to particular behaviors exhibited and/or otherwise performed by the parties to the game. The behavior-based incentives can be advantages and/or other items. The advantages and/or other items can relate to the game itself (e.g., an advantageous position, etc.), or can be unrelated to the game. In an embodiment, step 1020 can involve mapping respective ones of the behavior-based incentives in the set to respective behaviors that can be exhibited and/or performed by the parties to the game. In this way, a particular behavior will be associated with a particular behavior-based incentive.

The set of behavior-based incentives can be determined, for example, to encourage behaviors such as additional present/future game play and/or present/future purchasing behavior (for example, advantages in present/future games, discounts on future video rentals, etc.). Thus, the set of behavior-based incentives can be determined in order to induce the parties into playing the game in the future and/or purchasing something in the future. In further detail, the set of behavior-based incentives can be determined in order to induce the parties into, for example, renting or purchasing specified content including, but not limited to, a single title, a certain studio's title, popular content, old content, new content, foreign content, and so forth. Additionally, the behavior-based incentives can include watching media content that has also been watched/rated by the social network corresponding to a party to the game. Moreover, the incentives can be linked to a media distribution service (e.g., a multimedia on-demand service). In such a case, the behavior-based incentives can be linked to a party's past consumption of media from that service, to media the service wants to promote, and/or so forth. Further, competition between the parties can be used to increase current or future media consumption. These and other examples of determining the set of behavior-based incentives in order to obtain a particular result are readily determined by one of ordinary skill in the art given the teachings of the present principles provided herein, while maintaining the spirit of the present principles.

At step 1030, store the set of behaviors, the set of behavior-based incentives, and the mapping there between in a memory device.

At step 1040, monitor non-game-play behavior (e.g., number of videos rented, etc.). As is readily appreciated by one of ordinary skill in the art, such monitoring is behavior dependent and, thus, the hardware and other support necessary for such monitoring is readily determined by one of ordinary skill in the art depending upon the particular non-game-play behavior to be monitored.

At step 1050, monitor game play behavior in the game using, for example, an image capture device.

At step 1060, provide an indication, to at least one party of the two or more parties, that the at least one party has earned one or more of the behavior-based incentives, responsive to the at least one party exhibiting or performing one or more of the behaviors.

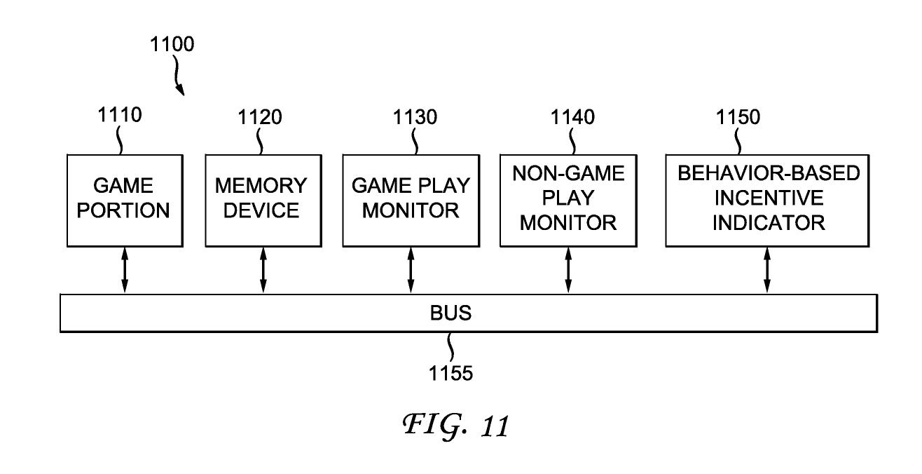

FIG. 11 shows a game 1100, in accordance with an aspect of the present principles. The game 1100 is playable by at least two parties who compete against each other. The game 1100 includes a game portion 1110, a memory device 1120, a game play monitor 1130, a non-game-play monitor 1140, and a behavior-based incentive indicator 1150, interconnected by a bus 1155. It is to be appreciated that while game 1100 is essentially shown as an electronic game in the embodiment of FIG. 11, the present principles can also be used with games in which the game portion 1110 is not (or is only partially) implemented in electronic form. For example, the present principles can be applied to board games, and so forth, while maintaining the spirit of the present principles.

The game portion 1110 is the portion of the game 1100 that the two parties interact with for the purpose of playing the game 1100. The memory device 1120 stores a set of behaviors, a set of behavior-based incentives, and a mapping there between. The game play monitor 1130 monitors game play behaviors, that is, behaviors relating to the playing of the game. The game play monitor 1130 can include, for example, but is not limited to, a camera, a speaker, and so forth. The non-game-play monitor 1140 monitors non-game-play behaviors. For example, the non-game-play monitor 1140 can interface with a purchasing website to receive purchasing behavior therefrom relating to the parties to the game. The behavior-based incentive indicator 1150 indicates that one of the parties earned a particular behavior-based incentive responsive to the party exhibiting or performing a particular behavior corresponding to the particular behavior-based incentive.

A description will now be given of some of the many attendant advantages/features of the present invention, some of which have been mentioned above. For example, one advantage/feature is a method that includes storing, in a memory device, a set of behavior-based incentives for a game in which two or more parties compete against each other. The method further includes providing an indication, to at least one party of the two or more parties, that the at least one party has earned one or more of the behavior-based incentives responsive to the at least one party exhibiting or performing one or more predetermined behaviors.

Another advantage/feature is the method as described above, wherein the behavior-based incentives are at least one of advantages in the game and physical items.

Yet another advantage/feature is the method wherein the behavior-based incentives are at least one of advantages in the game and physical items as described above, wherein the physical items are any of related to the game and unrelated to the game.

Still another advantage/feature is the method as described above, wherein the game is played and incentivized with respect to a multimedia on demand service, and wherein at least one of the predetermined behaviors comprises at least one of renting and purchasing a greatest amount of media from the multimedia on demand service over a specified time period.

Moreover, another advantage/feature is the method as described above, further including determining the set of behavior-based incentives to encourage at least one of additional present game play, future game play, additional present purchasing behavior, and future purchasing behavior.

Further, another advantage/feature is the method as described above, wherein the one or more predetermined behaviors comprise taking over territory in the game.

Also, another advantage/feature is the method wherein the one or more predetermined behaviors comprise taking over territory in the game as described above, wherein the territory in the game is linked to past multimedia consumption for a purpose of enabling the behavior-based incentives.

Additionally, another advantage/feature is the method wherein the one or more predetermined behaviors comprise taking over territory in the game as described above, wherein the territory in the game is linked to media content being promoted by a media distribution service.

Moreover, another advantage/feature is the method as described above, wherein the one or more predetermined behaviors comprise re-consumption of previously consumed media.

Further, another advantage/feature is a method that includes monitoring game play behavior in a game in which two or more parties compete against each other using an image capture device. The method further includes providing an indication, to at least one party of the two or more parties, that the at least one party has earned one or more behavior-based incentives responsive to the at least one party exhibiting or performing one or more predetermined behaviors during the game.

Also, another advantage/feature is the method as described above, wherein the one or more predetermined behaviors are comprised in a set of predetermined behaviors, the predetermined behaviors in the set comprising the game play behavior and non-game-play behavior.

Additionally, another advantage/feature is the method as described above, further including mapping respective ones of the behavior-based incentives to respective ones of the one or more predetermined behaviors.

Moreover, another advantage/feature is the method as described above, wherein the incentives are at least one of advantages in the game and physical items, and the physical items are any of related to the game and unrelated to the game.

Further, another advantage/feature is the method as described above, wherein the game is played and incentivized with respect to a multimedia on demand service, and wherein at least one of the predetermined behaviors comprises at least one of renting and purchasing a greatest amount of media from the multimedia on demand service over a specified time period.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method, comprising:
storing, in a memory device, a set of behavior-based incentives for a game in which two or more parties compete against each other; and
providing an indication, to at least one party of the two or more parties, that the at least one party has earned one or more of the behavior-based incentives responsive to the at least one party exhibiting or performing one or more predetermined behaviors.

2. The method of claim 1, wherein the behavior-based incentives are at least one of advantages in the game and physical items.

3. The method of claim 2, wherein the physical items are any of related to the game and unrelated to the game.

4. The method of claim 1, wherein the game is played and incentivized with respect to a multimedia on demand service, and wherein at least one of the predetermined behaviors comprises at least one of renting and purchasing a greatest amount of media from the multimedia on demand service over a specified time period.

5. The method of claim 1, further comprising determining the set of behavior-based incentives to encourage at least one of additional present game play, future game play, additional present purchasing behavior, and future purchasing behavior.

6. The method of claim 1, wherein the one or more predetermined behaviors comprise taking over territory in the game.

7. The method of claim 6, wherein the territory in the game is linked to past multimedia consumption for a purpose of enabling the behavior-based incentives.

8. The method of claim 6, wherein the territory in the game is linked to media content being promoted by a media distribution service.

9. The method of claim 1, wherein the one or more predetermined behaviors comprise re-consumption of previously consumed media.

10. A method, comprising:
monitoring game play behavior in a game in which two or more parties compete against each other using an image capture device; and
providing an indication, to at least one party of the two or more parties, that the at least one party has earned one or more behavior-based incentives responsive to the at least one party exhibiting or performing one or more predetermined behaviors during the game.

11. The method of claim 10, wherein the one or more predetermined behaviors are comprised in a set of predetermined behaviors, the predetermined behaviors in the set comprising the game play behavior and non-game-play behavior.

12. The method of claim 10, further comprising mapping respective ones of the behavior-based incentives to respective ones of the one or more predetermined behaviors.

13. The method of claim 10, wherein the incentives are at least one of advantages in the game and physical items, and the physical items are any of related to the game and unrelated to the game.

14. The method of claim 10, wherein the game is played and incentivized with respect to a multimedia on demand service, and wherein at least one of the predetermined behaviors comprises at least one of renting and purchasing a greatest amount of media from the multimedia on demand service over a specified time period.

15. A game, comprising:
a game portion for use by parties to the game during a playing of the game;
a memory device for storing a set of behaviors and a set of behavior-based incentives, the set of behaviors including game play behaviors and non-game-play behaviors;
a game play monitor for monitoring the game play behaviors;
a non-game-play monitor for monitoring the non-game-play behaviors; and
a behavior-based incentive indicator for indicating that one of the parties earned a particular one of the behavior-based incentives responsive to the one of the parties exhibiting or performing a particular one of the behaviors corresponding to the particular one of the behavior-based incentives.
